(19) United States
(12) Patent Application Publication
(10) Pub. No.: US 2003/0156121 A1
(43) Pub. Date: Aug. 21, 2003

(54) Compensation for adjacent pixel interdependence

(76) Inventor: Donald Henry Willis, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/078,776

(22) Filed: Feb. 19, 2002

(51) Int. Cl. G09G 5/00

(52) U.S. Cl. 345/606

(57) ABSTRACT

A method and system for reducing pixel interdependence errors in an imager caused by adjacent pixel drive interdependence. The method compares a first brightness control level for a first pixel to a brightness control level for at least one adjacent pixel of the imager. Based on the results of the comparing step, the system modifies the first brightness control level for the first pixel to compensate for the pixel interdependence effect. A modified brightness control level is determined for the first pixel that results in an actual brightness for the first pixel in the presence of pixel interdependence effect, which more closely approximates the actual brightness that would result from the un-modified first brightness control level in the absence of pixel interdependence effect.

### CROSS REFERENCE TO RELATED APPLICATIONS—NOT APPLICABLE

(Not Applicable)

### BACKGROUND OF THE INVENTION

1. Field of the Invention

This invention relates to the field of video systems utilizing imagers that have adjacent pixel interdependence, and more particularly to a system for correcting the effects of such interdependence.

2. Description of Related Art

There have been many new developments in various types of electronic displays and video imaging devices. One example of such technology is liquid crystal on silicon (LCOS). Although these various types of display devices have many advantages, some of these newer technologies suffer from adjacent pixel interdependence. Generally speaking adjacent pixel interdependence is a distortion in a brightness level of one pixel of an imager resulting from the effects of one or more adjacent pixels. The cause of such interdependence can be varied depending on the particular type of display or imaging technology. For example, in the case of LCOS, the problem has been primarily attributed to disclination error. In order to understand this effect, a brief explanation of LCOS is helpful.

LCOS can be thought of as one large liquid crystal formed on a silicon wafer. The silicon wafer is divided into an incremental array of tiny plate electrodes. A tiny incremental region of the liquid crystal is influenced by the electric field generated by each tiny plate and the common plate. Each such tiny plate and corresponding liquid crystal region are together referred to as a cell of the imager. Each cell corresponds to an individually controllable pixel. A common plate electrode is disposed on the other side of the liquid crystal. Each cell, or pixel, remains lighted with the same intensity until the input signal is changed, thus acting as a sample and hold. The pixel does not decay, as is the case with the phosphors in a cathode ray tube. Each set of common and variable plate electrodes forms an imager. One imager is provided for each color, in this case, one imager each for red, green and blue.

A light engine having an LCOS imager has a severe non-linearity in the display transfer function, which can be corrected by a digital lookup table, referred to as a gamma table. The gamma table corrects for the differences in gain in the transfer function. Notwithstanding this correction, the strong non-linearity of the LCOS imaging transfer function for a normally white LCOS imager means that dark areas have a very low light-versus-voltage gain. Thus, at lower brightness levels, adjacent pixels that are only moderately different in brightness need to be driven by very different voltage levels. This produces a fringing electrical field having a component orthogonal to the desired field. This orthogonal field produces a brighter than desired pixel, which in turn can produce undesired bright edges on objects. The presence of such orthogonal fields is denoted disclination. The image artifact caused by disclination and perceived by the viewer is sometimes referred to as sparkle. This is because an area of the picture in which disclination occurs can appear to have sparkles of light over the underlying image. In effect, dark pixels affected by disclination are too bright, often five times as bright as they should be. Sparkle comes in red, green and blue colors, for each color produced by the imagers. In general, these brightness distortions are said to be attributable to adjacent pixel interdependence.

LCOS imaging is a new technology and disclination is a new kind of problem. However, the problem of brightness distortions caused by adjacent pixel interdependence is not necessarily limited to LCOS imagers. Other types of displays and imagers can suffer similar brightness distortions in adjacent pixels. The physical cause of these distortions may not be exactly the same for all types of imagers but the effects can be broadly characterized as adjacent pixel interdependence.

Various proposed solutions to the problem of adjacent pixel interdependence include signal processing the entire luminance component of the picture. However, such systems tend to degrade the quality of the entire picture. The trade-off for reducing the effects of adjacent pixel interdependence in such prior art systems is a picture with virtually no horizontal sharpness at all. Picture detail and sharpness simply cannot be sacrificed in that fashion.

One skilled in the art would expect the problem of adjacent pixel interdependence to be addressed and ultimately solved in the imager, as that is where the problem originates. However, in an emerging technology such as LCOS, there simply isn't an opportunity for parties other than the manufacturer of the LCOS imagers to fix the problem in the imagers. Moreover, there is no indication that an imager-based solution would be applicable to all types of imagers. Accordingly, there is an urgent need to provide a solution to this problem that can be implemented without modifying the imager.

### SUMMARY

The invention concerns a method and system for reducing pixel brightness distortions caused by adjacent pixel interdependence. In its most basic form, the method involves estimating an adjacent pixel interdependence effect upon a first pixel at a first brightness control level as caused by at least one adjacent pixel at a second brightness control level. Based on this estimation, the first brightness control level for the first pixel is modified to compensate for the effects of adjacent pixel interdependence. More particularly, the estimating step can include calculating an estimated pixel brightness control level that would result in an actual brightness for the first pixel in the absence of pixel interdependence effects, that is equal to the actual brightness that would result from the first pixel brightness control level in the presence of said pixel interdependence effects.

According to one aspect of the invention, the estimating step can include comparing the brightness control level of the first pixel to the brightness control levels for adjacent pixels appearing immediately before and/or after the first pixel in a row. A pixel interdependence function can be used to calculate the effects of pixel interdependence on actual picture brightness. The pixel interdependence function can be a complex or simple function. The modifying step is intended to determine a modified brightness control level for the first pixel that results in an actual brightness for the first pixel in the presence of pixel interdependence, which more closely approximates the actual brightness that would result from the un-modified first brightness control level in the absence of adjacent pixel interdependence. Both the comparing and the modifying steps can be iterated for improved results.

The invention can also include a system for reducing brightness distortion errors in a display or imager caused by adjacent pixel interdependence. An estimator is provided for estimating an adjacent pixel interdependence effect upon a first pixel at a first brightness control level as caused by at least one adjacent pixel at a second brightness control level. More particularly, the estimator can calculate an estimated pixel brightness control level that would result in an actual brightness for the first pixel in the absence of pixel interdependence effects, that is equal to the actual brightness that would result from the first pixel brightness control level in the presence of the pixel interdependence effects.

According to one aspect of the invention, the estimator can compare the brightness control level of the first pixel to the brightness control levels of one or more adjacent pixels. For example, the adjacent pixels may appear immediately before and after the first pixel in a row. The estimator can also modify the difference in accordance with a pixel interdependence function to appropriately adjust for the relative effects of pixel interdependence. The pixel interdependence function can be a complex or simple function.

An iterative adjustment stage can modify the first brightness control level for the first pixel to compensate for the pixel interdependence errors. The iterative adjustment stage determines a modified brightness control level for the first pixel that results in an actual brightness for the first pixel in the presence of pixel interdependence errors, which more closely approximates the actual brightness that would result from the un-modified first brightness control level in the absence of pixel interdependence errors. Iterative estimator and iterative adjustment stages can be provided for improved approximations.

### BRIEF DESCRIPTION OF THE FIGURES

FIG. 1 is a block diagram useful for showing a first stage of an iterative algorithm that can be used for reducing the apparent effects of adjacent pixel interdependence.

FIG. 2 is a diagram useful for showing how a control signal can control a brightness for each pixel in a row of pixels in an imager or display.

FIG. 3 is a block diagram useful for showing an iterative algorithm that can be used in any of the stages following the algorithm in FIG. 1 for reducing the apparent effects of adjacent pixel interdependence.

FIG. 4 is a detailed block diagram of an estimator that can be used in FIGS. 1 and 2.

### DETAILED DESCRIPTION

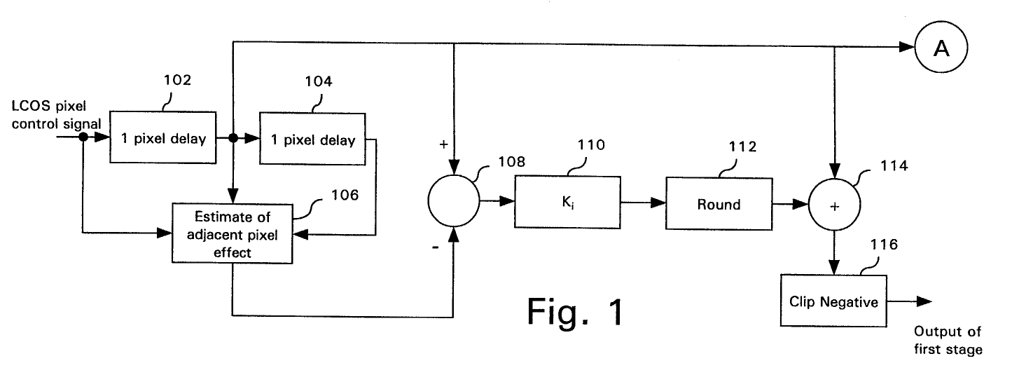

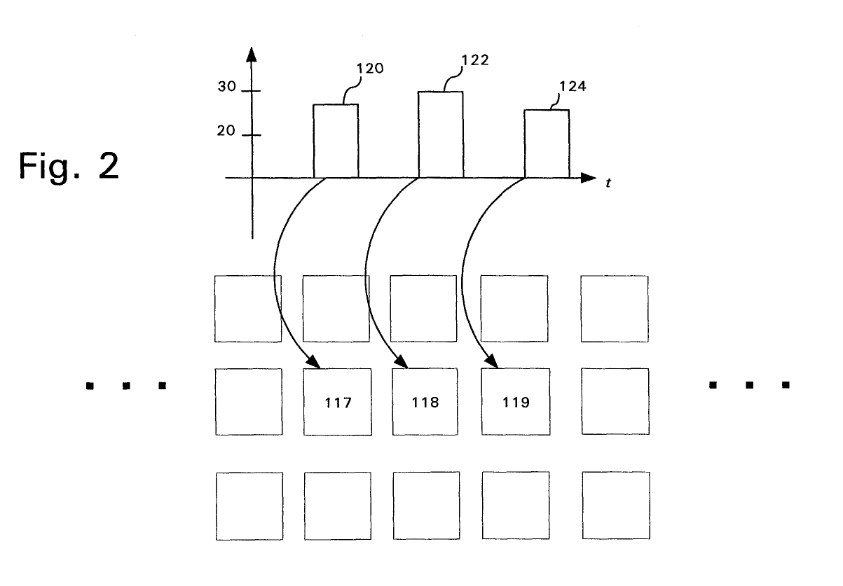

The invention reduces brightness distortions in an electronic display or imager caused by adjacent pixel interdependence. This is accomplished by estimating a pixel interdependence effect upon a first pixel at a first brightness control level as caused by at least one adjacent pixel at a second brightness control level, and using the result to iteratively pre-adjust or modify the pixel brightness control signal for the first pixel to compensate for brightness distortions caused by the adjacent pixels. This process can be implemented using any suitable method for selectively controlling a pixel brightness control signal to compensate for the known effects of adjacent pixel interdependence. For convenience in understanding the invention, FIGS. 1 and 2 are examples of how the process can be implemented. However, it should be understood that the invention is not limited to the precise embodiments shown.

FIG. 1 is a block diagram of a first stage of a brightness control system according to a preferred embodiment of the invention. The input to the system is a series of brightness control levels for pixels to be displayed in an imager. The input signal can be an analog or digital signal that indicates, either directly or indirectly, the intensity or brightness assigned to each pixel in a particular row. For example, the input can be an analog or digital representation of desired pixel brightness that has only an indirect relationship to the actual control voltage for the selected pixel. According to a preferred embodiment, the term brightness control level as used herein can refer to a conventional IRE level. A full white signal is 100 IRE units while an absolute black signal is 0 IRE units. However, the invention is not limited in this regard and a brightness control level can also be expressed in terms of a digital word. For example, using an eight bit digital word to designate brightness would permit the expression of 256 separate brightness control levels. Further, the pixel brightness control level adjustment here is preferably performed prior to any gamma correction that may be necessary for a particular display device. Brightness control level adjustments to correct pixel interdependence errors can be performed after gamma correction but would require more complex processing.

The brightness control level input signal provides the necessary data representing the desired brightness level of each pixel. The input, whether in digital, IRE or analog form, is preferably supplied for each pixel one following another in a row. In this way, the control signal provides the brightness level information for each row of pixels, and for all the rows that follow.

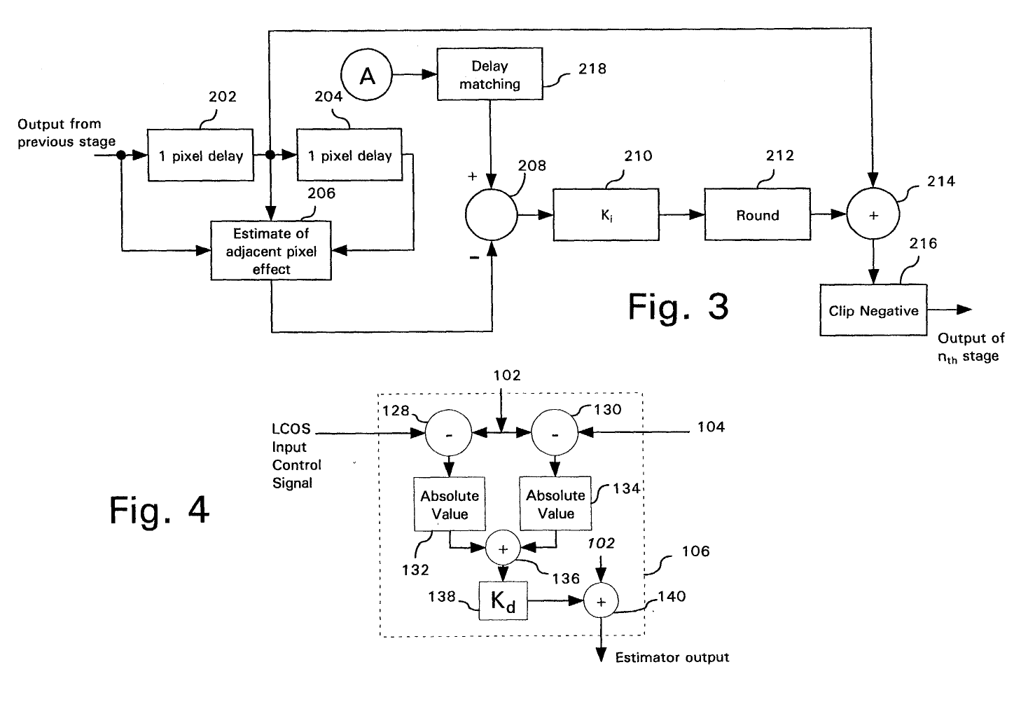

FIG. 2 is a drawing useful for representing an input signal comprising a series of brightness values 120, 122, 124 that can indicate the brightness for a series of pixels 117, 118, 119 respectively. However, the invention is not limited in this regard and other forms of pixel control signals are also possible. In FIG. 1, pixel delay elements 102 and 104 are provided so that the brightness control level of three horizontally adjacent pixels 117, 118, 119 can be evaluated as shown in estimator 106. A connector “A” in FIG. 2 is used to illustrate that the output of delay element 102 is also provided as an input to the next stage of the system shown in FIG. 3.

Estimator 106 receives the brightness control levels 122, 120 and 124 of a middle pixel 118 and two outer pixels 117, 119 respectively. It uses these values to estimate the pixel interdependence effects of the outer pixels on the middle pixel. The output of the estimator 106 is an estimate of the actual brightness level that will result for the middle pixel 118 in the presence of pixel interdependence errors using the original, unmodified, brightness control level for that pixel. In order to make this estimate, estimator 106 preferably evaluates the difference in pixel brightness control levels between the adjacent pixels and preferably provides an output that is based on the pixel interdependence relationship. The actual pixel interdependence relationship can be defined by a pixel interdependence function, which can be a simple function or a complex function. The pixel interdependence function will generally be dependent on the particular imager used, but can be determined either experimentally or by means of computer modeling. In any case, the particular imager used will determine the transfer function of the estimator.

The estimated pixel brightness value output from estimator 106 can be passed to an iterative adjustment stage. The iterative adjustment stage compares the estimated brightness control level for a pixel 118, as determined by estimator 106, and produces a modified brightness control level for the pixel 118. The modified brightness control level is intended to result in an actual brightness for the pixel 118 that is at least partially corrected for pixel interdependence errors. More particularly, the modified brightness control level for pixel 118 is intended to more closely approximate, in the presence of pixel interdependence errors from pixels 117, 119, the same actual brightness that would result from the un-modified brightness control level for pixel 118 in the absence of such pixel interdependence errors. In FIG. 1, the iterative adjustment stage can include difference block 108, weighting block 110, rounding block 112, summing block 114, and clipper 116. However, the invention is not limited in this regard, and other specific arrangements for the iterative adjustment stage are possible without departing from the intended scope of the invention.

In difference block 108, the estimated brightness value from estimator 106 can be subtracted from the original pixel control signal brightness value assigned to pixel 118. The difference between the original and the estimated brightness control levels for pixel 118 can be multiplied by an iteration constant (between zero and unity) in weighting block 110. The iteration constant serves as a weighting value for the the brightness control system stage shown in FIG. 1, and is generally selected so as to give a desired weight to the pixel brightness corrections indicated by the particular stage. The iteration constant can be adjusted for achieving the most accurate estimation in the smallest number of iterations. If the constant is too small, it can require an excessive number of iterations to calculate modified brightness values. If the constant is too large, it can cause oscillation. An iteration constant of about 0.68 has been found to provide acceptable results.

The weighted output is rounded in block 112 and will serve as a correction value. This correction value is added to the original brightness control level in summing block 114. Since negative brightness values are not possible, a negative clipper is provided in block 116. The output from block 116 is a modified brightness control level for pixel 118 that is intended to more closely approximate, in the presence of pixel interdependence effects from pixels 117, 119, the same actual brightness that would result from the un-modified brightness control level for pixel 118 in the absence of such pixel interdependence effects.

The foregoing brightness control level adjustment process described relative to pixel 118 in FIG. 1 is preferably performed on each pixel in a display or imager. Notably, as each pixel is modified in the first stage as described relative to FIG. 1, such scaling will naturally affect adjacent pixels. For example, the changed brightness control values of adjacent pixels 117, 119 resulting from the process in FIG. 1 will produce pixel interdependence effects with respect to pixel 118 that differ from those anticipated in the processing of pixel 118 as performed in FIG. 1. In order to reduce these effects, additional stages of scaling can be added as shown in FIG. 3. Of course, each stage or iteration of processing will have some effect on the brightness values of adjacent pixels. However, it has been found by calculation that reasonably accurate modified pixel brightness values can be obtained with between about two to seven iterations.

FIG. 3 shows a second stage that can be used to implement the brightness control system as described herein. The processing shown in FIG. 3 can also be used for any of the iterative processing stages following second stage. Briefly, in each such stage represented by FIG. 3, a new brightness control level for pixel 118 is computed in estimator 206 in a manner similar to that used in the first stage, except that the brightness control level for the pixels 117, 118 and 119 will also have been corrected to some extent in the previous stage. Accordingly, estimator 206 will produce a new value for anticipated brightness of pixel 118 taking into account the adjustments made to pixels 117, 118 and 119 in the previous stage.

In the iterative adjustment stage portion of the system in FIG. 3, the new estimated brightness value output from estimator 206 is subtracted in block 208 from the original brightness control level for pixel 118. This difference (which will generally be a negative number) can be multiplied by a weighting factor Kᵢ in weighting block 210, rounded in rounding block 212, and summed in block 214 with the corrected brightness control level for pixel 118 from the previous stage. Any negative values will be clipped in block 216 before the output is passed to the next stage. This additional stage of processing produces another correction value that is closer to producing the correctly adjusted brightness value for pixel 118, as compared to the result from the previous stage. A number of stages can be used to achieve whatever accuracy of picture rendition is desired. However, 2 to 7 stages have been found to produce good results. After the last stage, the brightness control level can be passed to the imager drive circuitry.

It may be noted that the processing stage in FIG. 3 is nearly identical to the processing stage in FIG. 1. One important difference, however, is that the difference calculated in block 208 is based on the original brightness control level value from FIG. 1 rather than the modified value from delay block 202.

Referring now to FIG. 4, there is shown in greater detail the operation of an estimator 106, it being understood that estimator 206 can operate in a similar manner. It should be understood that the estimator in FIG. 4 is configured for one particular design of LCOS imager having a particular pixel interdependence. Accordingly, it will be appreciated that different imagers can require different estimators, the arrangement shown in FIG. 4 being merely one example.

The pixel interdependence function used in the estimator 106 can be determined experimentally or through the use of computer modeling. However, it is generally agreed that adjacent pixels in an LCOS imager operated in a normally white mode can increase a pixel's brightness by a non-decreasing function of the absolute difference between the pixel drive values. Accordingly, FIG. 4 shows an exemplary block diagram of an estimator that assumes a linear dependence on the absolute difference in adjacent pixel brightness control levels.

In FIG. 4, the estimator 106 can receive as inputs the pixel brightness control level for pixel 118 from delay block 102, the pixel brightness control level for pixel 117 from delay block 104 and can receive, undelayed, the brightness control level of pixel 119. The difference between the pixel values are determined in difference blocks 128, 130 and the absolute value of this difference is determined in blocks 132, 134. The results are summed together in summing block 136 and the output is multiplied by a pixel interdependence factor K_{d}. The interdependence factor will generally be a value between zero and one. The actual value of the interdependence factor K_{d} will be determined by the particular imager used. The value can be determined experimentally or through the use of computer modeling. For example a K_{d} value of 0.75 has been found acceptable for modeling certain LCOS imagers. In summing block 140, the scaled value is summed with the original pixel brightness value from block 102. The result is used as the output of estimator 106.

An example is helpful in order to better understand the brightness control system as described above. As shown in FIG. 2 a pixel can have an IRE brightness value of between zero and one hundred (zero being the darkest and 100 being the brightest). The brightness values 120, 122, 124 for pixels 117, 118, 119 are 28 IRE, 30 IRE and 27 IRE, respectively. Applying these values to the input of estimator 106, will give an output value from absolute value blocks 132 and 134 equal to 2 and 3 respectively. Summing these values together in summing block 136 will give an output of 5. Multiplying this value by Kd=0.75 will give an output of 3.75. Summing this correction value with the original brightness control level 30 for pixel 118 gives an estimator output value of 33.75 IRE. This estimator output value reflects the somewhat brighter actual brightness of pixel 118 that will result from pixel interdependence errors associated with pixels 117 and 119.

In block 108, the output of 33.75 IRE is subtracted from the original brightness control level for pixel 118 as received from delay block 102. The difference is −3.75. In weighting block 110, this brightness control level is multiplied by the weighting factor that shall be assumed as 0.68. The output is −2.55 and this value is rounded to −3.0 in rounding block 112. Finally, in summing block 114, the correction value −3.0 is added to the original brightness control level 30 for pixel 118. The output is 27 IRE and since this is a positive value, the negative clipper block 116 simply passes the value unchanged to the input of the next stage as shown in FIG. 3. Notably, the first stage has reduced the brightness control level for pixel 118 from 30 to 27 in this case to account for the pixel interdependence errors associated with pixels 117 and 119. If the output of the summing block 114 had been negative, this would indicate that the pixel 118 would need to be driven to a negative brightness level in order to compensate for pixel interdependence effects. Since negative brightness values are not possible the negative value is simply made equal to zero.

Notably, the present invention can be realized in hardware, software, or a combination of hardware and software. A machine readable storage for implementing the delay and processing algorithms as described herein can be realized in a centralized fashion in one computer system, for example in a control CPU associated with a display, or in a distributed fashion where different processing elements are spread across several interconnected hardware elements. Any kind of computer system or other apparatus adapted for carrying out the methods described herein is acceptable.

Alternatively, a typical combination of hardware and software for carrying out the invention could be a general purpose computer system with a computer program that, when loaded and executed, controls the computer system and a display system, such that it carries out the methods described herein. The present invention can also be embedded in a computer program product which comprises all the features enabling the implementation of the methods described herein, and which when loaded in a computer system, is able to carry out these methods. A computer program in the present context can mean any expression, in any language, code or notation, of a set of instructions intended to cause a system having an information processing capability to perform a particular function either directly or after either or both of the following: (a) conversion to another language, code or notation; and (b) reproduction in a different material form.

What is claimed is:

1. A method for reducing pixel interdependence distortion, comprising:
estimating a pixel interdependence effect upon a first pixel at a first brightness control level as caused by at least one adjacent pixel at a second brightness control level; and
responsive to said estimating step, modifying said first brightness control level for said first pixel to compensate for said pixel interdependence effect.

2. The method according to claim 1 wherein said estimating step further comprises calculating an estimated pixel brightness control level that would result in an actual brightness for said first pixel in the absence of said pixel interdependence effects, that is equal to the actual brightness that would result from said first pixel brightness control level in the presence of said pixel interdependence effects.

3. The method according to claim 1 wherein said estimating step further comprises comparing said brightness control level of said first pixel to said brightness control levels for adjacent pixels appearing immediately before and after said first pixel in a row.

4. The method according to claim 1 wherein said estimating step further comprises calculating a difference in brightness control levels as between said first pixel and said at least one adjacent pixel.

5. The method according to claim 4 wherein said estimating step further comprises scaling said difference by a pixel interdependence function.

6. The method according to claim 5 wherein said pixel interdependence function is a simple linear function. The method according to claim 1 wherein said modifying step further comprises determining a modified brightness control level for said first pixel that results in an actual brightness for the first pixel in the presence of said pixel interdependence effect, which approximates the actual brightness that would result from the unmodified first brightness control level in the absence of said pixel interdependence effect.

7. The method according to claim 1 further comprising iterating said estimating and said modifying steps.

8. A system for reducing pixel interdependence errors in an imager caused by adjacent pixel drive interdependence comprising:
an estimator for estimating the pixel interdependence effect upon a first pixel at a first brightness control level as caused by at least one adjacent pixel at a second brightness control level; and
an iterative adjustment stage responsive to said estimator for modifying said first brightness control level for said first pixel to compensate for said pixel interdependence effect.

9. The system according to claim 9 wherein said estimator calculates an estimated pixel brightness control level that would result in an actual brightness for said first pixel in the absence of said pixel interdependence effects, that is equal to the actual brightness that would result from said first pixel brightness control level in the presence of said pixel interdependence effect.

10. The system according to claim 9 wherein said estimator compares said brightness control level of said first pixel to said brightness control levels for adjacent pixels appearing immediately before and after said first pixel in a row.

11. The system according to claim 9 wherein said estimator calculates a difference in brightness control levels as between said first pixel and said at least one adjacent pixel.

12. The system according to claim 12 wherein said estimator scales said difference by a pixel interdependence function.

13. The system according to claim 13 wherein said pixel interdependence function is a simple linear function.

14. The system according to claim 9 wherein said iterative adjustment stage determines a modified brightness control level for said first pixel that results in an actual brightness for the first pixel in the presence of said pixel interdependence effect, which more closely approximates the actual brightness that would result from the un-modified first brightness control level in the absence of said pixel interdependence effect.

15. The system according to claim 9 further comprising cascaded stages of said estimator and said iterative adjustment stage for iteratively calculating a final modified brightness control level.
